(19) United States
(12) Patent Application Publication
(10) Pub. No.: US 2001/0029891 A1
(43) Pub. Date: Oct. 18, 2001

(54) Apparatus and method for forming ultra-thin film of semiconductor device

(75) Inventors: Ki Young Oh, Sungnam (KR); Yong Ku Baek, Seoul (KR)

Correspondence Address: OSTROLENK FABER GERB & SOFFEN, 1180 AVENUE OF THE AMERICAS, NEW YORK, NY, 100368403

(73) Assignee: Jusung Engineering Co., Ltd.

(21) Appl. No.: 09/835,498

(22) Filed: Apr. 16, 2001

(30) Foreign Application Priority Data
Apr. 18, 2000 (KR) 20239/2000

(51) Int. Cl. B05C 11/00

(52) U.S. Cl. 118/722; 118/666

(57) ABSTRACT

An apparatus for forming a ultra-thin film of a semiconductor device includes: a reactive chamber consisting of an upper container and a lower container junctioned by an O-ring; a suscepter installed inside the reactive chamber for supporting a target substrate on which a ultra-thin film is to be formed; at least two gas supply pipes for respectively supplying at least two material gases into the reactive chamber to form a ultra-thin film on the substrate; gas supply controllers respectively installed at the gas supply pipes to repeatedly supply the material gases into the chamber; a gas outlet for discharging the gas from the chamber; remote plasma generators installed outside the reactive chamber and connected to the gas supply pipes for activating the material gases supplied through the gas supply pipes; and a temperature controller for controlling the temperature inside the chamber in a heat exchange method, the temperature controller being installed to surround the chamber. Even though the deposition method for alternately supplying the material gases is used, the deposition speed of the film can be quickened, so that the process time period for the fabrication of a semiconductor device can be shortened.

### BACKGROUND OF THE INVENTION

1. Field of the Invention

The present invention relates to a semiconductor device fabrication apparatus, and more particularly, to an apparatus and method for forming an ultra-thin film required for a semiconductor device.

2. Description of the Background Art

Recently, as semiconductor devices are being more integrated, the size of the device is being more reduced, resulting in various changes to fabrication method of a semiconductor device.

Especially, in case of a device of which a design rule is lower than 0.13 μm, it is impossible to use the conventionally used material any longer, for which, new materials are required to meet the requirements of the electric characteristics of each device.

For example, as a gate insulation film, a high dielectric constant material such as Al₂O₃, HfO₂ or ZrO₂ instead of the conventional thermal oxide film (that is, a silicon oxide film thermally oxidized at an oxygen atmosphere).

In addition, as a capacitor dielectric film of a DRAM, a high dielectric constant material having a component of such as a BST (Barium-Strontium-Titanate) or a PZT (Lead-Zirconium-Titanate) draws more attention instead of a silicon nitride film by using a chemical vapor deposition.

The reason for this is that a semiconductor device having a fine pattern needs a very thin film.

Thus, in order to successfully form a very thin film (more or less 100 Å) with the above materials, a new thin film formation technique is required different from the conventional MOCVD (metal organic chemical vapor deposition) method. In this respect, a representative new technique is an ALD (atomic layer deposition) technique.

Unlike the conventional chemical vapor deposition method in which material of component elements constituting a thin film are simultaneously supplied to a substrate to deposit a thin film, the ALD thin film forming technique is to deposit a thin film by atomic layers by repeatedly supplying materials alternately to a substrate, which is widely adopted to formation of a thin film of a semiconductor device these days.

According to the ALD method, since a thin film can be formed simply by the chemical reaction on the substrate surface, a uniform thickness of thin film can be grown regardless of irregularities of the surface of the substrate. In addition, since the deposition of a film is in proportion to a material supply cycle rather than being in proportion to time period, the thickness of the film can be precisely controlled. A textbook edited by T Suntola and M. Simpson eds. “Atomic Layer Epitaxy”, Blackie, London, 1990 provides good explanation to the ALD method.

FIG. 1 is a sectional view of a reactor 100 of the ALD apparatus in accordance with a conventional art.

With reference to FIG. 1, a reactive chamber 100 includes a lower container 110a and an upper container 110b which are separated to provide reactive spaces. Gases for forming a thin film is repeatedly supplied onto a substrate 130 inside the reactor sequentially in a horizontal gas flow through a gas inlet 140 formed at one side of the reactor 100.

A method for forming an aluminum oxide film (Al₂O₃) by using the reactive chamber is disclosed in the ‘Applied Physics Letters’, vol. 71, page 3604, 1997.

According to this method, in brief, in a state that the temperature in the reactive chamber 100 is raised up to be maintained at the temperature of 150° C. and the temperature of the substrate 130 mounted on a suscepter 120 inside the reactive chamber 100 is maintained at 370° C. Trimethyl aluminum, purge argon (Ar), vapor and purge argon are repeatedly supplied sequentially for 1 second, 14 seconds, 1 second and 14 seconds. This process in which trimethyl aluminum, purge argon (Ar), vapor and purge argon are repeatedly supplied sequentially for 1 second, 14 seconds, 1 second and 14 seconds is defined as one period for supplying materials. Accordingly, one period for supplying materials is 30 seconds obtained by adding the injection time period of gases.

FIG. 2 is a graph of the material gas supply order and period. In this drawing, the horizontal axis indicates a process time period, but the length is not always proportion to time period.

Trimethyl aluminum and vapor to be used for the reaction are respectively introduced into the reactive chamber, and as soon as the process is finished, they are discharged through a gas outlet 150 by a purging argon (Ar) which is supplied immediately through the gas inlet 140.

When an aluminum oxide film is formed in the above described method, it is formed 0.19 nm by 0.19 nm on the substrate per material supply cycle (30 seconds). Accordingly, the total film deposition speed is 0.38 nm/min.

However, this speed is so slow that the number of substrates processed per time period is very small compared with the conventional chemical deposition method.

Thus, due to its disadvantage in a productivity, it is not adopted to the process for fabricating a semiconductor device. The reason for this is that the ALD process has the characteristics that injecting of a source gas, purging of an inert gas, injecting of a reactive gas and purging of an inert gas are repeatedly performed, so that the processes are complicated and the number of processed substrates per time period, that is, a productivity, is not basically improved.

The ALD process will now be described in detail.

As shown in FIG. 2, the source gas (trimethyl aluminum) is injected into the chamber and one molecule of the source gas is attached on the semiconductor substrate. And then, in order to completely remove the source remaining in the chamber, an inert gas such as Ar is injected to purge the chamber.

Subsequently, a reactive gas (vapor) which is reactable with the molecular of the source gas attached on the substrate is injected into the chamber. At this time, the substrate in the chamber is heated at an arbitrary temperature so that the source gas can be well adsorbed to the substrate. The heating temperature is determined depending on the type of a source gas and a surface state of the substrate. Generally, the adsorption of the reactive gas is mainly dependant on the deflection of a temperature.

And then, the chamber is purged with an inert gas to completely remove the residual reactive gas in the chamber, thereby forming a ultra-thin film of one-atomic layer.

Next, the serial process, that is, the process for fabricating a ultra-thin film of one period, that the source gas and the inert gas are again injected to purge the chamber and the source is again injected and purged is repeatedly performed until a desired thickness of thin film is obtained.

In order to optimize the ALD method in an actual process, the volume of a chamber should be minimized, and the gas supply and gas discharging should be optimized to perform effectively supplying an purging of gas. For this reason, the reactive apparatus having the structure of FIG. 1 has been proposed.

However, the conventional ALD technique and apparatus have the following problems.

That is, when the process is performed, the gas supply cycle is divided into several steps of injecting the source gas and the reactive gas and purging the gas. Thus, the number of the processed semiconductor substrate per time period is small, which is a burden on improvement of a productivity.

Meanwhile, in case that a multicomponent material such as a BST is technically deposited by using the conventional ALD method and apparatus, since an adsorption temperature and a reactive temperature are varied depending on a source gas containing each component, the temperature of the substrate should be differently set and controlled when the source gas is injected. This would inevitably face a considerable reduction of a throughput of a wafer per time period (because after a temperature is changed, it should wait a certain time to stabilize the temperature), resulting in much decrease of a productivity.

In addition, since the temperature needs to be changed frequently, it is hardly expected to form a thin film successfully.

Thus, with the conventional ALD method or apparatus, formation of a thin film of the multicomponent material is not possible in view of productivity.

In order to solve the problem, when each source gas of the reactive chamber is adsorbed, the temperatures are differently set and then a heat capacity of the reactive chamber is made great to stabilize the temperature within a short time, or a source gas is previously activated, so that when the adsorption or chemical reaction are performed for the gas in the reactive chamber, the dependency on the temperature can be minimized.

### SUMMARY OF THE INVENTION

Therefore, an object of the present invention is to provide a technique and related apparatus for overcoming the problem of the conventional ALD technique and limit to the process in the conventional reactive chamber performing the ALD process.

Another object of the present invention is to provide an apparatus and method for forming a ultra-thin film of a semiconductor device which is capable of heightening a deposition speed of a film by removing a purging process of an inert gas and shortening a supply cycle of a material gas.

Still another object of the present invention is to provide an apparatus and method for forming an ultra-thin film of a semiconductor device which is capable of depositing a thin film of a multicomponent material even without having a temperature stabilization time by minimizing a adsorption of a reactive gas and a temperature sensitivity of a chemical reaction when materials having different components, that is, for example, two-component system materials, are deposited by activating a material gas.

Yet another object of the present invention is to provide an optimized apparatus for providing a process by which the above mentioned problems can be solved.

To achieve these and other advantages and in accordance with the purpose of the present invention, as embodied and broadly described herein, there is provided an apparatus for forming a ultra-thin film of a semiconductor device including: a reactive chamber consisting of an upper container and a lower container junctioned by an O-ring; a suscepter installed inside the reactive chamber for supporting a target substrate on which a ultra-thin film is to be formed; at least two gas supply pipes for respectively supplying at least two material gases into the reactive chamber to form a ultra-thin film on the substrate; gas supply controllers respectively installed at the gas supply pipes to repeatedly supply the material gases into the chamber; a gas outlet for discharging the gas from the chamber; remote plasma generators installed outside the reactive chamber and connected to the gas supply pipes for activating the material gases supplied through the gas supply pipes; and a temperature controller for controlling the temperature inside the chamber in a heat exchange method, the temperature controller being installed to surround the chamber.

To achieve the above objects, the apparatus for forming a ultra-thin film of a semiconductor device of the present invention further includes a grounding unit connected both to the upper container and to the lower container of the reactive chamber to clean inside of the chamber; and an RF power generator connected to the suscepter to apply an RF power to the suscepter.

To achieve the above objects, in the apparatus for forming a ultra-thin film of a semiconductor device of the present invention, a position controller for moving vertically the suscepter is additionally provided in the suscepter.

To achieve the above objects, in the apparatus for forming a ultra-thin film of a semiconductor device of the present invention, a vacuum pump is connected to the gas outlet.

To achieve the above objects, there is also provided a method for forming a ultra-thin film of a semiconductor by adopting the ultra-thin film forming apparatus, including the steps of: mounting a substrate on the suscepter; introducing different material gases into each of the gas supply pipes; selectively operating the remote plasma generators connected to each gas supply pipe and activating the material gas introduced into the gas supply pipes; repeatedly supplying the activated different material gases in each gas supply pipe into the chamber for a predetermined time period in turn. In this method, there is no step for supplying a purging gas between the steps for supplying the activated different material gases.

To achieve the above objects, in the step for supplying the activated material gas into the reactive chamber, after an activated material gas in the gas supply pipe is supplied to the reactive chamber, the gas inside the reactive chamber is vacuum-discharged through the gas outlet before a different activated material gas is supplied.

To achieve the above objects, in the method for forming a ultra-thin film of a semiconductor device, the ultra-thin film is one of Al₂O₃, HfO₂, ZrO₂, BST and PZT.

To achieve the above objects, there is also provided a method for forming a ultra-thin film of a multicomponent system consisting a first material gas component having a relatively high reactive temperature and adsorption temperature and a second material gas component having a relatively low reactive temperature and adsorption temperature of a semiconductor device by using the thin-film forming apparatus, including the steps of: mounting the substrate on the suscepter; introducing the first material gas into one of the gas supply pipes, and selectively operating the remote plasma generators to generate an activated first material gas; and injecting the activated first material gas and the non-activated second material gas through the different gas supply pipes into the reactive chamber for a predetermined time period in turn. In this method, there is no step for supplying a purge gas between the step for supplying the activated first material gas and the step for supplying the second material gas.

To achieve the above objects, in the method for forming a multicomponent ultra-thin film, the temperature inside the reactive chamber is constantly maintained during the step in which the activated first material gas and the non-activated second material gas are alternately supplied into the reactive chamber.

To achieve the above objects, in the method for forming a multicomponent ultra-thin film, in the step for supplying material gases, a step for vacuum-discharging the gas filled in the reactive chamber through the gas outlet to empty the chamber between the step of supplying the first material gas and the step for supplying the second material gas.

To achieve the above objects, in the method for forming a multicomponent ultra-thin film, the multicomponent thin film is a BST or a PZT.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic sectional view of a reactor of an ALD (Atomic Layer Deposition) in accordance with a conventional art;

FIG. 2 is a graph showing a gas supply cycle in accordance with the conventional art;

FIG. 3 is a schematic sectional view of a ultra-thin film forming apparatus in accordance with the present invention;

FIG. 4 is a diagram of a gas spray unit adopted to the ultra-thin film forming apparatus of FIG. 3 viewed from a substrate in accordance with the present invention;

FIG. 5 is a graph showing a gas supply cycle in accordance with one embodiment of the present invention; and

FIG. 6 is a graph showing a gas supply cycle in accordance with another embodiment of the present invention.

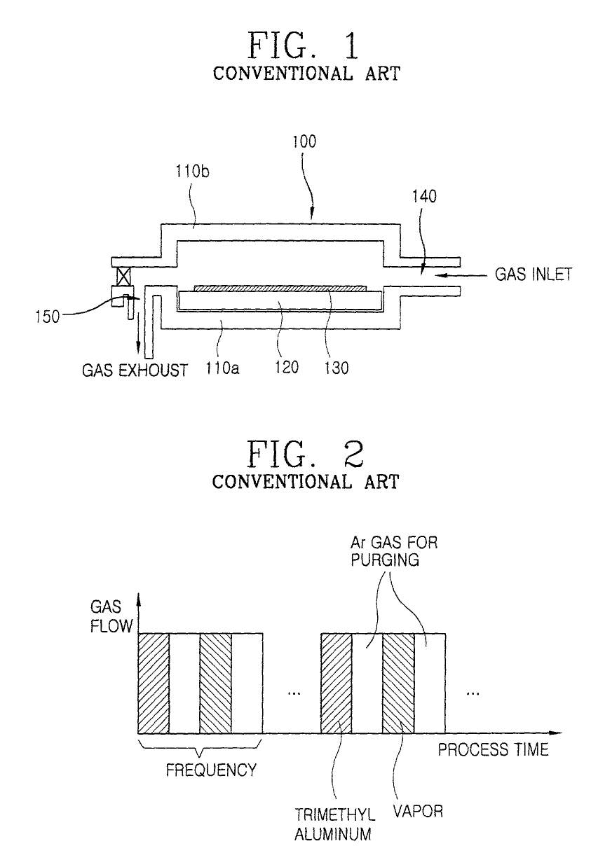

### DETAILED DESCRIPTION OF THE PREFERRED EMBODIMENTS

Reference will now be made in detail to the preferred embodiments of the present invention, examples of which are illustrated in the accompanying drawings.

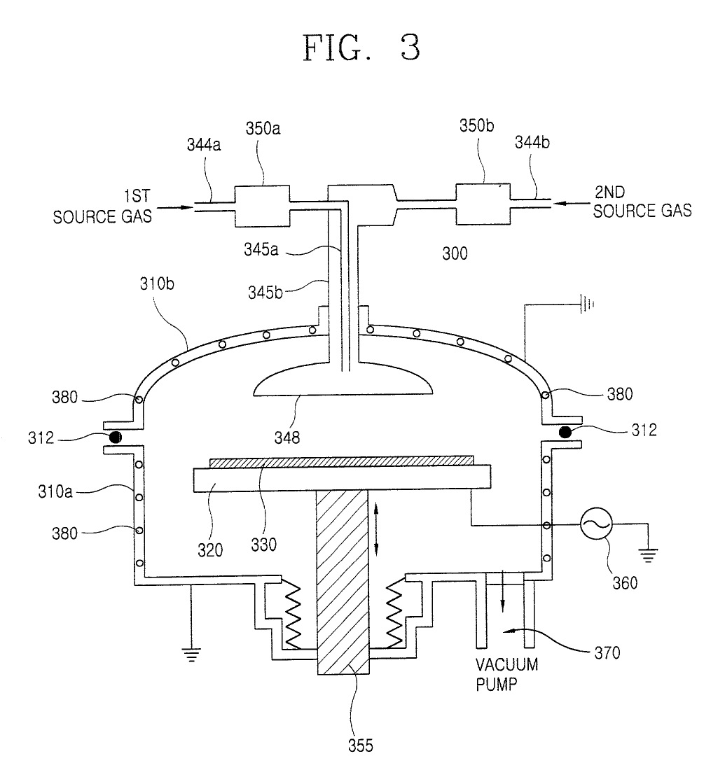

FIG. 3 is a schematic sectional view of a ultra-thin film forming apparatus (300) in accordance with the present invention.

With reference to FIG. 3, a lower chamber 310a and a dome-shaped upper chamber 310b are combined by an O-ring 312, to form a reactive chamber 310 having an isolated reactive space at the inner side thereof.

A first material gas supply pipe 344a is installed outside the reactive chamber 310. The first material gas supply pipe 344a is connected to one end of a first remote plasma generator 350a, and a first material gas induction tube 345a is connected to the other end of the first remote plasma generator 350a. The first material gas induction tube 345a penetrates the ceiling of the reactive chamber 310, being extendedly formed into the reactive chamber 310.

A gas spray unit 348 is installed at the end of the first material gas induction tube 345a. The gas spray unit 348 is installed at the upper portion inside the reactive chamber 310.

A second material gas supply pipe 344b is installed outside the reactive chamber 310. A second material gas supply pipe 344b is connected to one end of a second remote plasma generator 350b, and a second material gas induction tube 345b is connected to the other end of the second remote plasma generator 350b.

The second material gas induction tube 345b penetrates the ceiling of the reactive chamber 310, being extendedly formed into the reactive chamber 310. The second material gas induction tube 345b is extendedly formed at the upper portion inside the reactive chamber 310 and also connected to the gas spray unit 348 like the first material gas induction tube 345a.

The second material gas induction tube 345b surrounds the first material gas induction tube 345a.

In the ultra-thin film forming apparatus constructed as described, the first material gas is supplied subsequently through the first material gas supply pipe 344a, the first remote plasma generator 350a, the first material gas induction tube 345a and the gas spray unit 348 into the chamber.

The second material gas is supplied subsequently through the second material gas supply pipe 344b, the second remote plasma generator 350b, the second material gas induction tube 345b and the gas spray unit 348 into the chamber.

That is, the first material gas and the second material gas are induced into the reactive chamber 310 through different material gas supply pipes, so that a process for purging the material gas supply pipe and the reactive chamber before a different material gas is supplied can be applied after a material gas has been supplied.

In addition, time taken for injecting the second material gas after the first material gas has been injected can be shortened, so that time for the ultra-thin film forming process can be shortened.

Meanwhile, a suscepter 320 for supporting the semiconductor substrate 330 is installed at the lower portion inside the reactive chamber 310. The suscepter 320 is movable vertically (h).

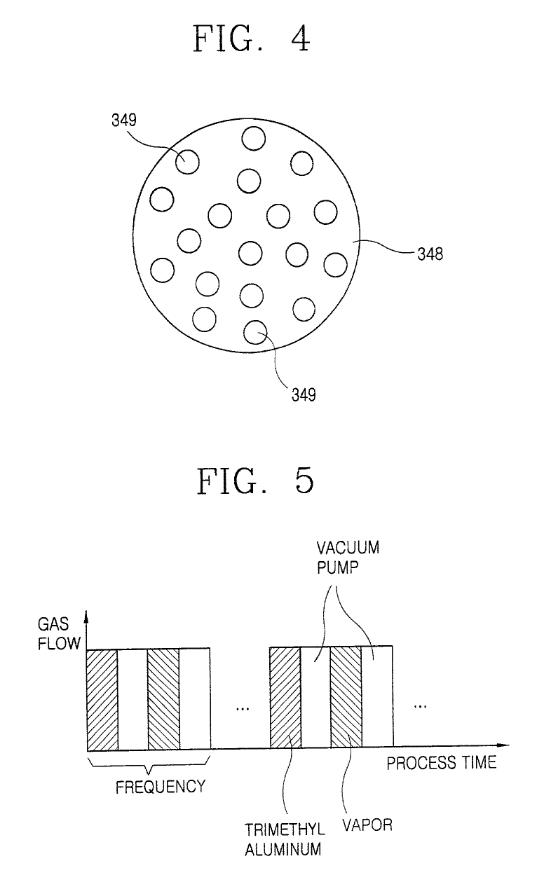

FIG. 4 is a diagram of a gas spray unit adopted to the ultra-thin film forming apparatus of FIG. 3 viewed from a substrate in accordance with the present invention.

As shown in FIG. 4, the gas spray unit 348 has a plurality of through holes 349 at the face facing the substrate 330, through which the first and the second material gases are dispersedly sprayed to the substrate 330 mounted on the suscepter 320.

In the preferred embodiment of the present invention, the gas spray unit 348 is adopted, but the gas is not necessarily supplied by the gas spray unit and an injector may be used to supply gases.

An RF power generator 360 is connected to the suscepter 320, and the lower and the upper chambers 310a and 310b are grounded.

Accordingly, after completion of the deposition process, in a state that the RF power generator 360 and one of the remote plasma generators 350a and 350b are operated, when a gas containing fluorine such as SF₆ is supplied through the gas supply pipe where the operated remote plasma generator is installed, the inside of the chamber can be effectively in-situ dry-cleaned and a plasma induced damage can be reduced.

A temperature controller 380 for controlling the temperature inside the chamber is installed at the inner wall face of the chamber in a manner of surrounding the chamber. The temperature controller is operated in a heat exchange method using a heat exchange medium, so that cooling and heating are all available.

A suscepter support 355 with a convey unit (not shown) attached is installed at the lower portion of the suscepter 320, so that the substrate 330 can be conveyed vertically (h) to come to the optimum position during the deposition process.

During the deposition process, the exhaust gas is discharged through a gas outlet 370 connected to a vacuum pump (not shown) such as a turbo molecular pump (TMP) and a booster pump.

The method for forming an Al2O3 thin film by using the apparatus of FIG. 3 in accordance with a first embodiment of the present invention will now be described.

After the substrate 330 is mounted on the suscepter 320, the gas inside the chamber is pumped through the gas outlet by using the TMP, the inside of the chamber is decompressed to a base pressure in the range of 1 mTorr˜0.5 Torr.

And then, in a state that the first remote plasma generator 350a is operated, H₂O vapor is injected to the first material gas supply pipe 344a and a trimethyl aluminum source gas is injected into the second material gas supply pipe 344b. In this respect, a gas flow controller (not shown) installed at the gas supply pipes is controlled on time basis, so that the activated H2O* vapor and the trimethyl aluminum gas are repeatedly supplied into the chamber alternately. Accordingly, compared with the conventional art in which the nonactivated material gas is supplied, the reaction on the surface of the substrate is accelerated, and thus, the deposition speed of the film can be heightened.

FIG. 5 is a graph showing a gas supply cycle in accordance with one embodiment of the present invention.

With reference to FIG. 5, the horizontal axis indicates a process time period, of which the length is not always in proportion to time period, and vacuum exhaustion is rapidly performed by the TMP (not shown) connected to the gas outlet 370.

The TMP used in the preferred embodiment of the present invention is capable of decompressing to the pressure of 10⁻⁸ Torr. In the process of supplying the material gas, the vacuum exhaustion is rapidly performed for the gas discharging rather than using a purging gas, so that the material gas supply cycle can be very shortened.

That is, one material supply cycle is trimethyl aluminum gas supplying ->vacuum exhaustion->H2O* vapor supplying->vacuum exhaustion, and this supply cycle is repeated. Accordingly, the material gas supply time period can be more lengthened for the same time period as that of the conventional art, the deposition speed of the film can become faster.

During the deposition of the ultra-thin film, the temperature inside the chamber is controlled to be in the range of 100˜500° C. by the temperature controller 380.

In the above descriptions, though the method for forming the Al₂O₃ film is presented, the material gases may be variably selected and a Si₃N₄ film, a TiN film, A Ta₂O₅ film, a PZT (PbZrTiO₃) film or BST (BaSrTiO₃) film may be formed.

In this respect, in case of the PZT film or the BST film of the multicomponent thin film, if the material gases are activated by using a remote plasma generator, an effect is expected that it has wider selection of parameters such as the temperature required for the reaction, that is, the process window is widened.

In other words, when the source gases of different multicomponent thin film which have different adsorption temperatures or reaction temperatures are injected, it is not necessary to set temperatures differently and control the temperatures in the chamber. The reason for this is that because the source gases having a relatively high reaction temperatures or adsorption temperatures are activated previously by the remote plasma generator, when the gases are subjected to the adsorption or a chemical reaction in the reactive chamber, the dependency on the temperature is minimized.

Especially, in case of deposition of a thin film using a source gas of an organic metal compound and its reactive gas, a reactive gas activated by the remote plasma is supplied in a state that the organic metal compound has been first adsorbed onto the substrate, so that the organic material can be used to be easily combined with the reactive gas and removed.

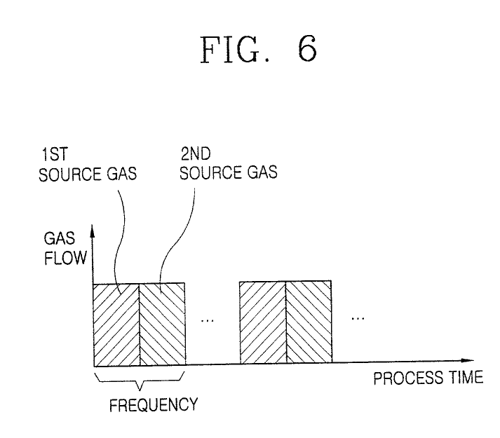

FIG. 6 is a graph showing a gas supply cycle in accordance with another embodiment of the present invention.

As shown in the drawing, the material gas supply pipes for the first material gas and the second material gas are separately installed, so that after the first material gas is supplied, the second material gas can be supplied without a chamber exhaustion process to form a ultra-thin film. That is, since one material gas supply cycle consists of only the first material gas supply step and the second material gas supply step, its process time can be very shortened.

As so far described, the apparatus and method for forming an ultra-thin film required for a semiconductor device has the following advantages.

That is, for example, first, even though the deposition method for alternately supplying the material gases is used, the deposition speed of the film can be quickened, so that the process time period for the fabrication of a semiconductor device can be shortened.

Secondly, since the temperature sensitivity of the chemical reaction and the adsorption of the reactive gases can be minimized, the thin film of a multicomponent system material can be deposited without having an extra temperature stabilization time period.

Lastly, since a film having a fine and an excellent properties can be formed, the characteristics of a semiconductor device can be improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. An apparatus for forming a ultra-thin film of a semiconductor device comprising:
a reactive chamber consisting of an upper container and a lower container junctioned by an O-ring;
a suscepter installed inside the reactive chamber for supporting a target substrate on which a ultra-thin film is to be formed;
at least two gas supply pipes for respectively supplying at least two material gases into the reactive chamber to form a ultra-thin film on the substrate;
gas supply controllers respectively installed at the gas supply pipes to repeatedly supply the material gases into the chamber;
a gas outlet for discharging the gas from the chamber;
remote plasma generators installed outside the reactive chamber and connected to the gas supply pipes for activating the material gases supplied through the gas supply pipes; and
a temperature controller for controlling the temperature inside the chamber in a heat exchange method, the temperature controller being installed to surround the chamber.

2. The apparatus of claim 1 further comprising:
a grounding unit connected both to the upper container and to the lower container of the reactive chamber to clean inside of the chamber; and
an RF power generator connected to the suscepter to apply an RF power to the suscepter.

3. The apparatus of claim 1, wherein a position controller for moving vertically the suscepter is additionally provided in the suscepter.

4. The apparatus of claim 1, wherein a vacuum pump is connected to the gas outlet.

5. A method for forming a ultra-thin film of a semiconductor by adopting the ultra-thin film forming apparatus, comprising the steps of:
mounting a substrate on the suscepter;
introducing different material gases into each of the gas supply pipes;
selectively operating the remote plasma generators connected to each gas supply pipe and activating the material gas introduced into the gas supply pipes;
repeatedly supplying the activated different material gases in each gas supply pipe into the chamber for a predetermined time period in turn,
wherein there is no step for supplying a purging gas between the steps for supplying the activated different material gases.

6. The method of claim 5, wherein the step for supplying the activated material gas into the reactive chamber includes a step of supplying a material gas activated in an arbitrary gas supply pipe and vacuum-discharging the gas filled in the reactive chamber through a gas outlet before a different activated material gas is supplied.

7. The method of claim 5, wherein the ultra-thin film is one of Al₂O₃, HfO₂, ZrO₂, BST and PZT.

8. A method for forming a ultra-thin film of a multicomponent system consisting a first material gas component having a relatively high reactive temperature and adsorption temperature and a second material gas component having a relatively low reactive temperature and adsorption temperature of a semiconductor device by using the thin-film forming apparatus of claim 1, comprising the steps of:
mounting the substrate on the suscepter;
introducing the first material gas into one of the gas supply pipes, and selectively operating the remote plasma generators to generate an activated first material gas; and
injecting the activated first material gas and the non-activated second material gas through the different gas supply pipes into the reactive chamber for a predetermined time period in turn
wherein there is no step for supplying a purge gas between the step for supplying the activated first material gas and the step for supplying the second material gas.

9. The method of claim 8, wherein the temperature inside the reactive chamber is constantly maintained during the step in which the activated first material gas and the nonactivated second material gas are alternately supplied into the reactive chamber.

10. The method of claim 1, wherein the step of supplying the material gases includes a step of vacuum-discharging the gas filled in the reactive chamber through the gas outlet to empty the chamber between the step of supplying the first material gas and the step for supplying the second material gas.

11. The method of claim 8, wherein the multicomponent thin film is a BST or a PZT.
